(19) United States
(12) Patent Application Publication
(10) Pub. No.: US 2016/0314428 A1
(43) Pub. Date: Oct. 27, 2016

(54) ACTION ANALYSIS SERVER, METHOD OF ANALYZING ACTION, AND PROGRAM FOR ACTION ANALYSIS SERVER

(71) Applicant: OPTiM Corporation, Saga (JP)

(72) Inventor: Shunji SUGAYA, Tokyo (JP)

(21) Appl. No.: 14/938,915

(22) Filed: Nov. 12, 2015

(30) Foreign Application Priority Data
Apr. 24, 2015 (JP) 2015-089727

(51) Int. Cl. G06Q 10/06; G06N 99/00; G06Q 50/26

(52) U.S. Cl. CPC G06Q 10/063114; G06Q 50/265; G06N 99/005

(57) ABSTRACT

The present invention is to provide an action analysis server learning the action of the user wearing a wearable terminal and informing a manager that a problem is occurred when the user takes any action other than the learned actions. The action analysis server 10 communicatively connected with the wearable terminal 100 worn by a user, regularly receives location data showing the user's current location, or acceleration data sensed by the wearable terminal 100 as action data from the wearable terminal 100, learns the user's action at the received time frame based on the received action data and generates a learning record, and executes an alert process when receiving action data not matched with the learning record from the wearable terminal.

### CROSS REFERENCE TO RELATED APPLICATIONS

This application claims priority to Japanese Patent Application No. 2015-089727 filed on Apr. 24, 2015, the entire contents of which are incorporated by reference herein.

### TECHNICAL FIELD

The present invention relates to an action analysis server, a method of analyzing action, and a program for action analysis server that analyzes the user's behavior.

### BACKGROUND ART

Recently, various wearable terminals with communication feature have been developed. For instance, as a wearable terminal, there are a wristband type, a ring type, a glasses type, and a watch type. Such a wearable terminal is used to enable the safety management of workers in the construction sites and employees in the facilities, etc.

For instance, a method is disclosed to secure the safety of workers by making two or more workers wear wearable terminals, and simulating radiation dose at the location of each wearable terminal based on the distance between each worker and the measured radiation dose (Patent Document 1).

### CITATION LIST

### Patent Literature

Patent Document 1: JP 2013-20422 A

### SUMMARY OF INVENTION

However, in Patent Document 1, to secure the safety of workers based on the distance between each worker and the measured radiation dose, the assumption is made that there exists two or more workers and the decision should be made whether it is safe or not based on an external data. Especially, if an unforeseen accident or problem occurs while the worker is working, the method is ineffectual.

In this context, the objective of the present invention is to provide an action analysis server, a method of analyzing action, and a program for action analysis server to learn the action of the user wearing a wearable terminal and inform a manager that a problem is occurred when the user takes any action other than the learned actions.

According to the first aspect of the present invention, an action analysis server communicatively connected with a wearable terminal worn by a user, includes:

a receiver unit that regularly receives location data showing a user's current location or an acceleration data sensed by the wearable terminal as action data from the wearable terminal;

an action learning unit that learns the user's action at the received a time frame based on the received action data and generating a learning record; and

an alert unit that executes an alert process when receiving action data not matched with the learning record from the wearable terminal.

According to the first aspect of the present invention, an action analysis server communicatively connected with a wearable terminal worn by a user, regularly receives location data showing a user's current location or an acceleration data sensed by the wearable terminal as action data from the wearable terminal, learns the user's action at the received a time frame based on the received action data and generates a learning record, and executes an alert process when receiving action data not matched with the learning record from the wearable terminal.

According to the second aspect of the present invention, the action analysis server according to the first aspect of the present invention further includes:

an action record generation unit that generates the action record based on the previously set action; and

a judgment unit that compares the action record with the received action data and judges whether or not the received action data is matched with the action record,

wherein the alert unit executes the alert process based on the judgment result from the judgment unit.

According to the second aspect of the present invention, the action analysis server according to the first aspect of the present invention generates the action record based on the previously set action, compares the action record with the received action data and judges whether or not the received action data is matched with the action record, and executes the alert process based on the judgment result from the judgment unit.

According to the third aspect of the present invention, the action analysis server according to the first or second aspect of the present invention, in which the alert unit executes a process to transmit a warning.

According to the third aspect of the present invention, the action analysis server according to the first or second aspect of the present invention, in which the alert unit executes a process to transmit a warning.

According to the fourth aspect of the present invention, the action analysis server according to any one of the first to the third aspects of the present invention, in which the alert unit notifies a time frame when an action data not match with the learning record is received.

According to the fourth aspect of the present invention, the action analysis server according to any one of the first to the third aspects of the present invention in which the alert unit notifies a time frame when an action data not match with the learning record is received.

The above aspects of the present invention are the category of an input device, but the categories of a method and a program have the same functions and effects.

According to the fifth aspect of the present invention, an action analysis method executed by an action analysis server communicatively connected with the wearable terminal worn by a user, including the steps of:

regularly receiving location data showing the user's current location, or acceleration data sensed by the wearable terminal as action data from the wearable terminal;

learning the user's action at the received time frame based on the received action data and generating a learning record; and

executing an alert process when receiving action data not matched with the learning record from the wearable terminal.

According to the sixth aspect of the present invention, a program product for use in an action analysis server, communicatively connected with the wearable terminal worn by a user, includes a non-transitory computer usable medium having a set of instructions physically embodied therein, the set of instructions including computer readable code, which when executed by the action analysis server causes the information processing unit to:

regularly receive location data showing the user's current location, or acceleration data sensed by the wearable terminal as action data from the wearable terminal;

learn the user's action at the received time frame based on the received action data and generate a learning record; and

execute an alert process when receiving action data not matched with the learning record from the wearable terminal.

According to the present invention, an action analysis server, a method of analyzing action and a program for action analysis server can be provided which learn the action of the user wearing a wearable terminal and inform a manager that a problem is occurred when the user takes any action other than the learned actions.

### BRIEF DESCRIPTION OF DRAWINGS

FIG. 1 shows an overview of the action analysis system 1.

FIG. 2 shows an overall schematic diagram of the action analysis system.

FIG. 3 shows a functional block diagram of the action analysis server 10, the wearable terminal 100, and the management terminal 60.

FIG. 4 shows a flow chart of the action analysis process executed by the action analysis server 10, the wearable terminal 100, and the management terminal 60.

FIG. 5 shows a GPS data table.

FIG. 6 shows a learning record data table.

FIG. 7 shows a conduct route of the user wearing the wearable terminal 100.

FIG. 8 shows a flow chart of the action analysis process executed by the action analysis server 10, the wearable terminal 100, and the management terminal 60.

FIG. 9 shows an action record table.

FIG. 10 shows an alert screen.

FIG. 11 shows an alert screen.

Embodiments of the present invention are described later with reference to the attached drawings. However, this is illustrative only, and the technological scope of the present invention is not limited thereto.

### Outline of Action Analysis System

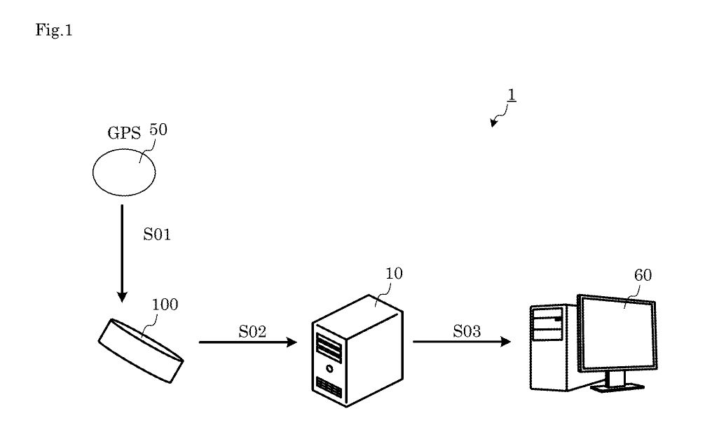

The outline of the present invention is described based on FIG. 1. The wearable terminal 100 has a shape to imitate the wristband, and user wears it on the wrist to be used. The wearable terminal 100 may be accessories including glasses and ring or a device or an information terminal such as smart phone provided with the functions to be described later. The wearable terminal 100 acquires the location data of the current position from GPS 50 (Step S01). The wearable terminal 100 also acquires the acceleration data sensed by an installed acceleration sensor. Moreover, the wearable terminal 100 may acquire the temperature data and other data by the temperature sensor and other sensors, etc. The wearable terminal 100, in the Step S01, acquires the location data, the acceleration data, the temperature data, or other data as action data.

The wearable terminal 100 regularly transmits the location data or the acceleration data acquired in Step S01 to the action analysis server 10 as action data (Step S02). The action analysis server 10 is an information device provided a function described later by software or hardware settings. For instance, the action analysis server 10 may be a general information device such as a server, a personal computer, a mobile phone, a smart phone, a slate terminal, a telephone with described functions, a net book terminal, and an electronic book terminal.

The action analysis server 10 learns the user's action wearing the wearable terminal 100 at the received time frame based on the received action data, generates a learning record, and stores the generated learning record. The action analysis server 10 compares the action data received from the wearable terminal 100 with the stored learning record and executes an alert process when current receiving action data not matched with the stored learning record (Step S03).

The action analysis server 10, when alert process is executed, transmits a warning notification to the management terminal 60 to warn that a user conducted an action not matched with the learning record (Step S04). Moreover, in alert process, the action analysis server 10 transmits the warning notification to the management terminal 60 to warn a time frame of receiving the action data not matched with the learning record (Step S04). The management terminal 60 is an information device provided with a function described later by software or hardware settings. For instance, the management terminal 60 may be a general information device such as a server, a personal computer, a mobile phone, a smart phone, a slate terminal, a telephone with described functions, a net book terminal, and an electronic book terminal.

The management terminal 60 displays the warning notification transmitted from the action analysis server 10.

### Action Analysis System

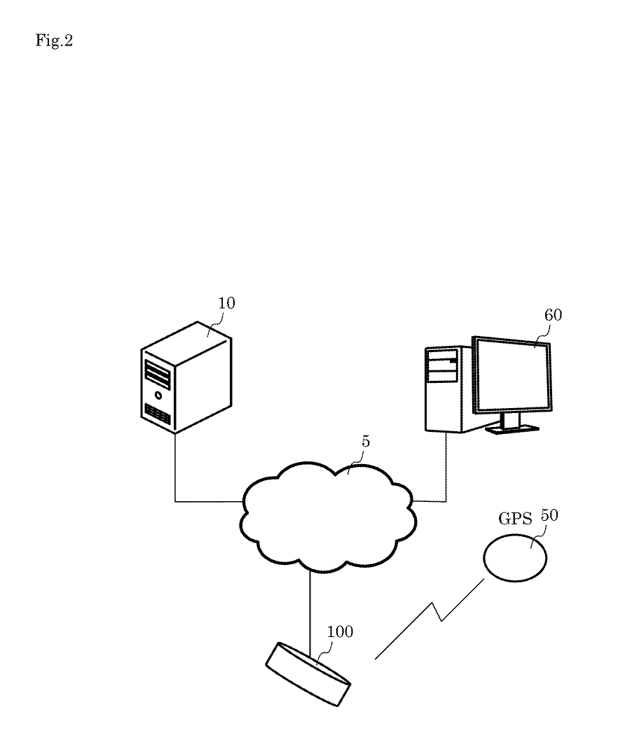

FIG. 2 shows an overall view of the action analysis system 1 according to a preferred embodiment of the present invention. The action analysis system 1 includes an action analysis server 10, a wearable terminal 100, a management terminal 60, a public line network 5, and GPS (Global Positioning System) 50.

The action analysis server 10 is communicatively connected with the wearable terminal 100 and the management terminal 60 through a public line network 5 or local area network. The communication in the action analysis system 1 may be wired or unwired.

The action analysis server 10 may be a general device enabling the computer processing, such as a server, a mobile phone, and a smart phone. The action analysis server 10 may also be a network device such as a router and a gateway or general information appliances such as a telephone, a netbook terminal, a slate terminal, an electronic book terminal, an electronic dictionary terminal, a portable music player, and a portable player and recorder.

The management terminal 60 is communicatively connected with the action analysis server 10 through a public line network 5 or local area network. The action analysis server 10 may be a general device enabling the computer processing, and a general information appliances such as a server, a mobile phone, a smart phone, a telephone, a net book terminal, a slate terminal, an electronic book terminal, an electronic dictionary terminal, a portable music player, and a portable player and recorder.

The wearable terminal 100 has a shape to imitate the wristband, and a user wears it on the wrist to be used. Moreover, the wearable terminal 100 acquires a current location data from GPS 50. Moreover, the wearable terminal 100 is installed with the acceleration sensor, and acquires the acceleration data sensed by the acceleration sensor as acceleration data sensed by the wearable terminal 100. Moreover, the wearable terminal 100 is installed with the thermometer, and acquires measured ambient temperature data and user's body temperature. The wearable terminal 100 provides with a clock function to acquire current time. Moreover, the wearable terminal 100 may be provided with other sensors and functions to acquire other data corresponding to the other sensors.

GPS 50 is multiple GPS satellites and transmits location information based on the demand from the wearable terminal 100. GPS 50 is general GPS satellites.

### Functions

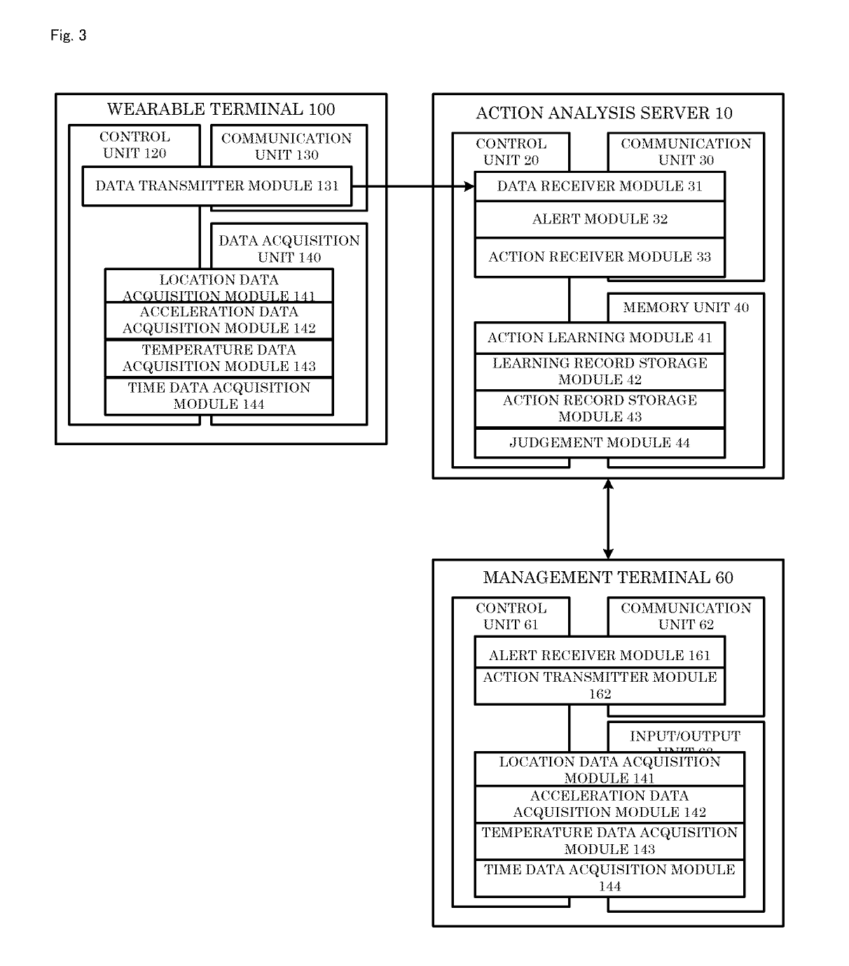

FIG. 3 shows a functional block diagram of the action analysis server 10, the wearable terminal 100, the management terminal 60 and GPS 50 and the relations between them.

The action analysis server 10 is provided with a control unit 20 including a central processing unit (hereinafter referred to as “CPU”), a random access memory (hereinafter referred to as “RAM”), and a read only memory (hereinafter referred to as “ROM”); and a communication unit 30 including a Wireless Fidelity or Wi-Fi® enabled device complying with, for example, IEEE 802.11, or a wireless device complying with the IMT-2000 standard such as the third and fourth generation mobile communication system. The communication unit may include a wired device for LAN connection.

The action analysis server 10 is also provided with a storage unit as a memory unit 40 such as a hard disk or a semiconductor memory to store data. The memory unit 40 stores a learning record and an action record described later.

In the action analysis server 10, the control unit 20 reads a predetermined program and cooperates with the communication unit 30 to achieve a data receiver module 31, an alert module 32, and an action receiver module 33. The control unit 20 also reads a predetermined program and cooperates with the memory unit 40 to achieve an action learning module 41, a learning record storage module 42, an action record storage module 43, and a judgement module 44.

The wearable terminal 100 is provided with a control unit 120 including a CPU, a RAM, and a ROM; and a communication unit 130 including a Wireless Fidelity or Wi-Fi® enabled device complying with, for example, IEEE 802.11, or a wireless device complying with the IMT-2000 standard such as the third and fourth generation mobile communication system. The communication unit may include a wired device for LAN connection.

Moreover, the wearable terminal 100 includes a GPS receiver, an acceleration sensor, a thermometer, and a clock as a data acquisition unit 140.

In the wearable terminal 100, the control unit 120 reads a predetermined program and cooperates with the communication unit 130 to achieve a data transmitter module 131. The control unit 120 also reads a predetermined program and cooperates with the data acquisition unit 140 to achieve a location data acquisition module 141, an acceleration data acquisition module 142, a temperature data acquisition module 143, and a time data acquisition module 144.

The management terminal 60 is provided with a control unit 61 including a CPU, a RAM, and a ROM; and a communication unit 62 including a Wireless Fidelity or Wi-Fi® enabled device complying with, for example, IEEE 802.11, or a wireless device complying with the IMT-2000 standard such as the third and fourth generation mobile communication system. The communication unit may include a wired device for LAN connection. Moreover, the management terminal 60 is provided with a input/output unit 63 outputting and displaying data and images that have been controlled by the control unit; and also a touch panel, a keyboard, a mouse, and the like that receive input from a manager.

In the management terminal 60, the control unit 61 reads a predetermined program and cooperates with the communication unit 62 to achieve an alert receiver module 161 and an action transmitter module 162. The control unit 61 also reads a predetermined program and cooperates with the input/output unit 63 to achieve an alert display module 163.

### Action Analysis Process

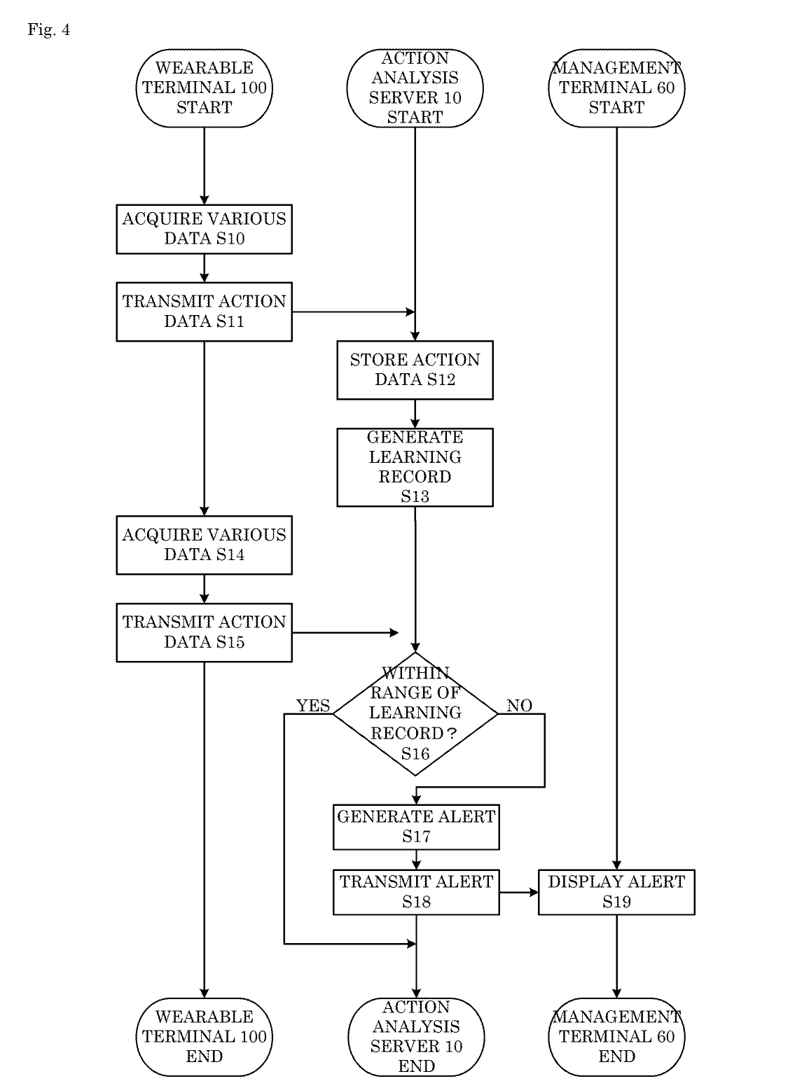

FIG. 4 shows a flow chart of the action analysis process executed by the action analysis server 10, the wearable terminal 100, and the management terminal 60. The process executed by the modules of the above-mentioned devices is explained together with this process.

The wearable terminal 100 acquires various data in the beginning (Step S10). In Step S10, the location data acquisition module 141 acquires the current location information received from GPS 50 as location data. Moreover, in Step S10, the acceleration data acquisition module 142 acquires the acceleration sensed by the acceleration sensor installed in the wearable terminal 100 as acceleration data. In Step S10, the temperature data acquisition module 143 acquires the user's body temperature and ambient temperature measured with the thermometer installed in the wearable terminal 100 as temperature data. In Step S10, the time data acquisition module 144 acquires current time measured with the clock installed in the wearable terminal 100 as time data. In Step S10, various data acquired by the wearable terminal 100 may not be limited to the data described above, and other data may be acquired.

The data transmitter module 131 of the wearable terminal 100 transmits various data acquired in Step S10 to the action analysis server 10 as action data (Step S11). In Step S11, the data transmitter module 131 regularly transmits the action data to the action analysis server 10. In Step S11, the data transmitter module 131 transmits various data to the action analysis server 10 at predetermined time interval, for instance, every 1 or 5 minutes, 30 seconds or other time interval.

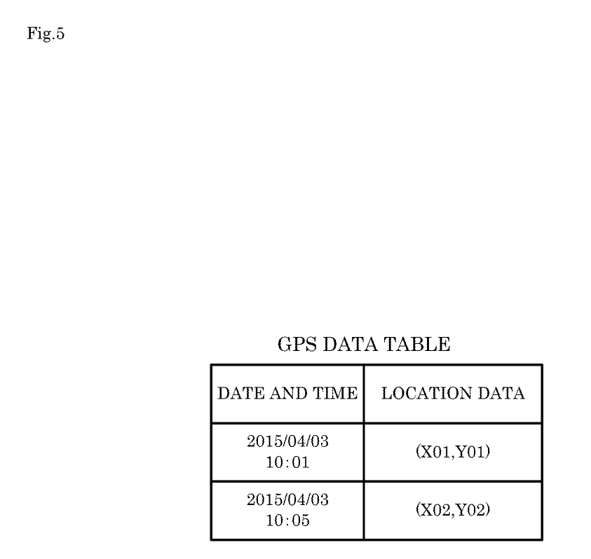

Next, the data receiver module 31 of the action analysis server 10 receives the action data transmitted from the wearable terminal 100. The action analysis server 10 stores the received action data in the memory unit 40 (Step S12). FIG. 5 shows a GPS data table stored in the memory unit 40. The GPS data table associates and stores the date and time of receiving the action data and the location data at this timing. Besides the location data, the memory unit 40 may store an acceleration data, temperature data and other data. In this case, the memory unit 40 may associate and store each data and date and time of receiving the data in the same way as the GPS data table.

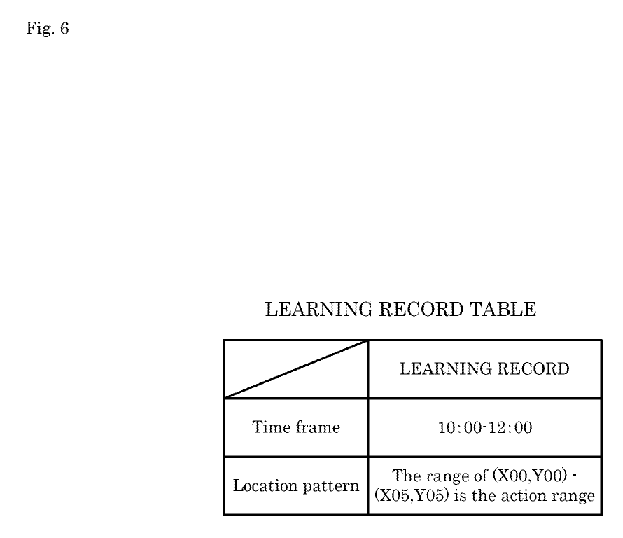

The action learning module 41 of the action analysis server 10 generates a learning record based on the received action data (Step S13). FIG. 6 shows a learning record generated by the action learning module 41. The learning record may associate and store a time frame and a user's location pattern at the time frame. A learning record table may store an acceleration pattern, a temperature pattern or other patterns in addition to a positional pattern.

In Step S13, the action learning module 41 extracts the action record at specific time frame among the received times. The action learning module 41 generates an extracted action record as a user's action pattern. Specifically as shown in FIG. 6, if a user has moved the range of (X00,Y00)-(X05,Y05) at the time frame of 10:00-12:00, the action learning module 41 generates a learning record with the association of this time frame and this moving range. The learning record storage module 42 of the action analysis server 10 stores the generated learning record in a learning record table.

The wearable terminal 100 again acquires various data in the same way as Step S10 (Step S14). Next, the data transmitter module 131 of the wearable terminal 100 transmits the action data to the action analysis server 10 in the same way as Step S11 (Step S15).

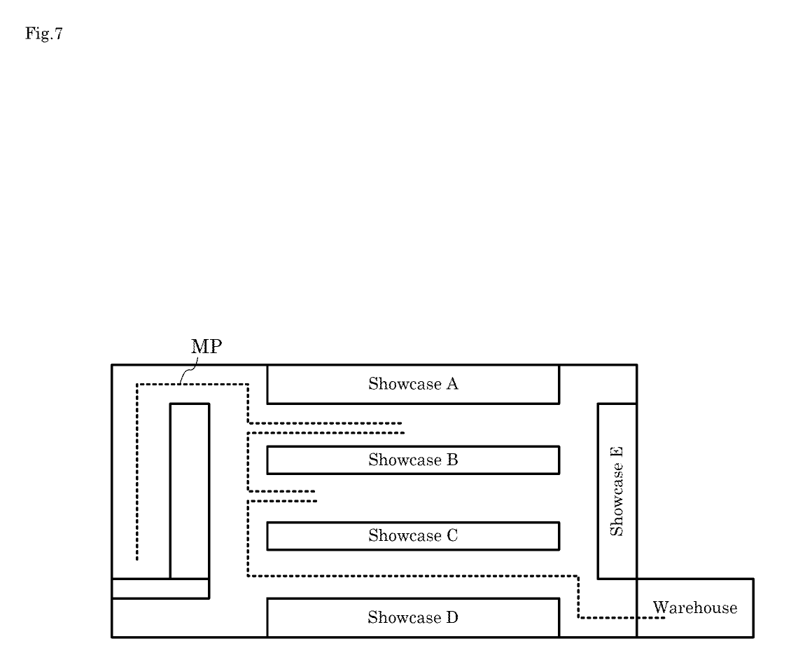

Here, the action analysis is described later based on the user's behavior in the store as shown in FIG. 7.

FIG. 7 shows a typical store and the conduct route MP of a user wearing the wearable terminal 100 is shown in the dotted line. Suppose the user wearing the wearable terminal 100 moved along the conduct route MP as shown in the dotted line at 10:00-12:00. The wearable terminal 100 acquires the action data of this conduct route MP at Step S14, and transmits the acquired action data to the action analysis server 10 in Step S15.

The judgment module 44 of the action analysis server 10 compares the received action data with the stored learning record, and judges whether or not the received action data is in the range of the stored learning record (Step S16). In Step S16, if the conduct route MP of the user is matched with the learned action pattern or within the range of the learned coordinates (Step S16: YES), the judgment module 44 terminates the process.

In Step S16, if the judgment module 44 judges an user's conduct route MP to be not matched with the learned action pattern (Step S16: NO), the alert module 32 generates an alert to warn a manager (Step S17).

The alert module 32 of the action analysis server 10 transmits the generated alert to the management terminal 60 (Step S18).

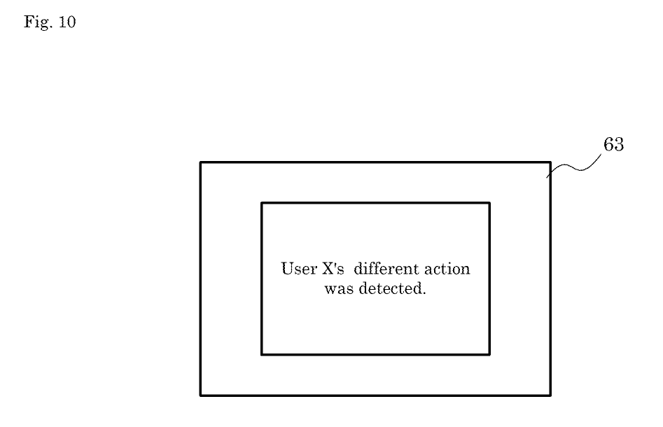

The alert receiver module 161 of the management terminal 60 receives the alert transmitted in Step S18. The alert display module 163 of the management terminal 60 displays the received alert in the input/output unit 63 as shown in FIG. 10. The procedure of the action analysis process is fully described above. The management terminal 60 may mark the action pattern of the user not matched with the previously set action record and display it as an alert.

In the action analysis process mentioned-above only a location pattern is described, but in Step S16, an acceleration pattern, a temperature pattern or other action patterns may be compared with action patterns stored in the learning records. In this case, the alert module 32 of the action analysis server 10 has only to transmit an alert corresponding to the compared action patterns to the management terminal 60, and the alert display module 163 of the management terminal 60 has only to display the received alert.

In this case, when the acceleration pattern is compared, the judgment module 44 has only to judge whether or not the learning acceleration pattern is matched with the acquired acceleration data. When the temperature pattern is compared, the judgment module 44 has only to judge whether or not the learning temperature pattern is matched with the acquired temperature data. When other action pattern is compared, the judgment module 44 has only to judge whether or not the learning other pattern is matched with the acquired other data.

### Action Record Judgment Process

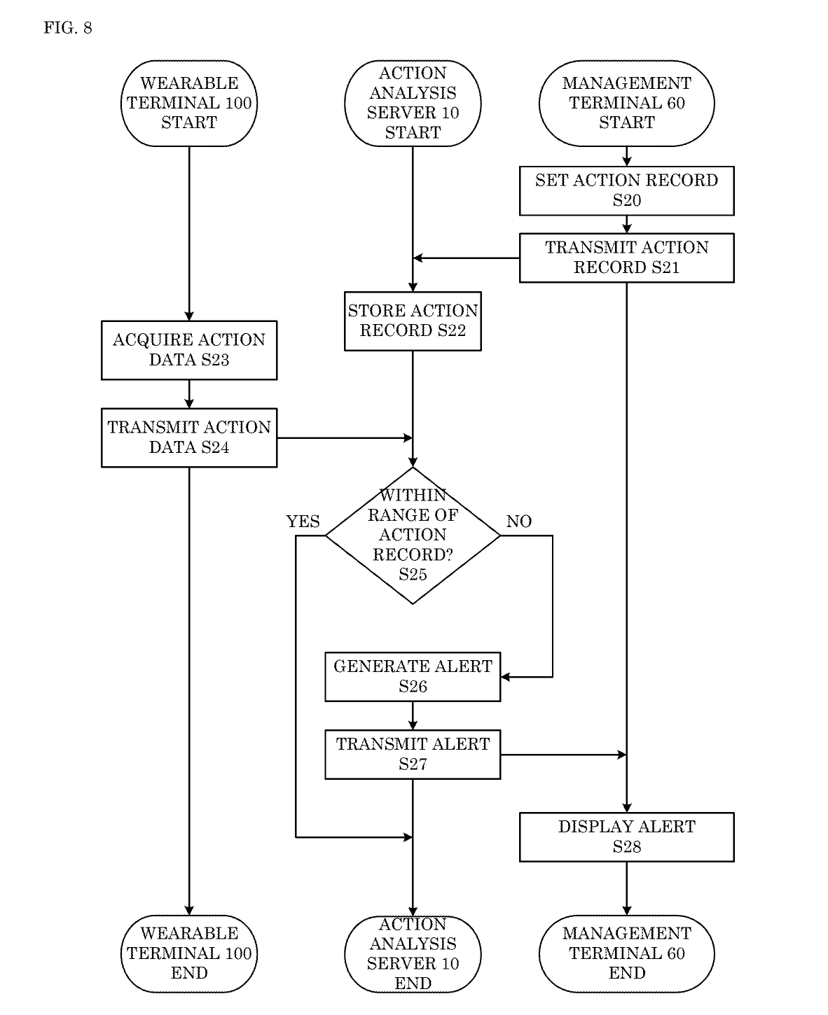

FIG. 8 shows a flow chart of the action analysis process executed by the action analysis server 10, the wearable terminal 100, and the management terminal 60. The process executed by the above-mentioned modules is explained together with this process.

Firstly in the management terminal 60, the action record is set by a manager who operates and inputs through the input/output unit 63 (Step S20). In Step S20, the manager sets the action pattern and routing for each user wearing the wearable terminal 100. In Step S20, the manager sets for instance soil improvement, material handling, and civil engineering work as routing. Moreover, the manager individually sets each user's action pattern as an action pattern in Step S20.

The action transmitter module 162 of the management terminal 60 transmits an action pattern and routing set for each user to the action analysis server 10 (Step S21).

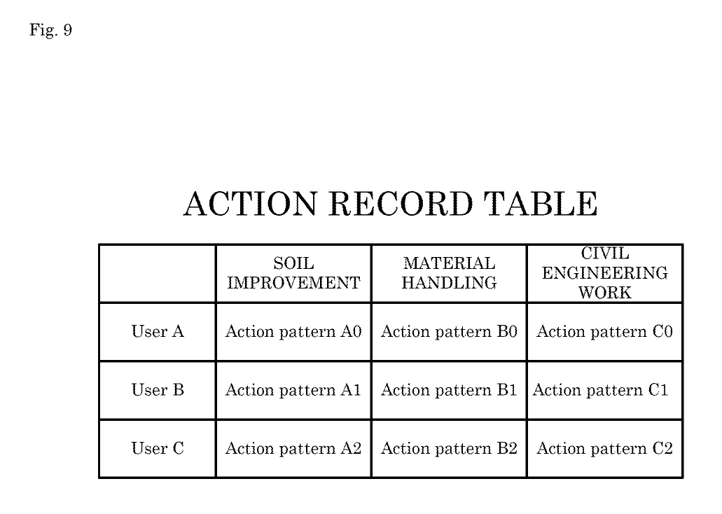

The action receiver module 33 of the action analysis server 10 receives the action pattern and routing transmitted from the management terminal 60. The action record storage module 43 of the action analysis server 10 stores the received action pattern and routing as the action record table shown in FIG. 9 (Step S22). In Step S22, the action record storage module 43 associates and stores each user with the routing and the action pattern. Specifically for user A, the soil improvement is associated as routing and action pattern A0 is associated as an action. Moreover, the material handling is associated as routing and action pattern BO is associated as an action. Moreover, the civil engineering work is associated as routing and action pattern C0 is associated as an action. In the same way, for user B and user C, an action pattern is associated with each routing.

Next, the wearable terminal 100 acquires various data in the same way as Step S10 described above (Step S23). In this process, it should be understood that the wearable terminal 100 acquiring the acceleration data is illustrated and described as explanatory purposes only. It is needle to say that location data, temperature data or other data may be acquired in the same way as Step S10 described above.

The data transmitter module 131 of the wearable terminal 100, in the same way as Step S11 described above, transmits the action data acquired in Step S23 to the action analysis server 10 (Step S24).

Next, the data receiver module 31 of the action analysis server 10 receives the action data transmitted from the wearable terminal 100. Based on the received action data and the action record stored in the memory unit 40, the judgment module 44 of the action analysis server 10 judges whether or not the received action data is within the range of the action record (Step S25).

In Step S25, the judgment module 44 judges whether or not the acceleration data received from the wearable terminal 100 of each user is matched with the routing and action of each user stored as the action record. For instance, when current routing is the soil improvement for user A, the action pattern set for the routing of the soil improvement for user A is the action pattern A0. Therefore, the acceleration data received from the wearable terminal 100 of user A is judged whether or not matched with the action pattern A0.

In Step S25, the judgment module 44 judges the routing based on the date and time included in the received action data. The judgment module 44 may judge the routing based on other data.

In Step S25, when the received action data is judged as within the range of the action record (Step S25: YES), the judgment module 44 terminates the process.

In Step S25, when the judgment module 44 judges the received action data is out of the range of the action record (Step S25: NO), the alert module 32 generates the alert to warn the manager (Step S26).

The alert module 32 of the action analysis server 10 transmits the generated alert to the management terminal 60 (Step S27).

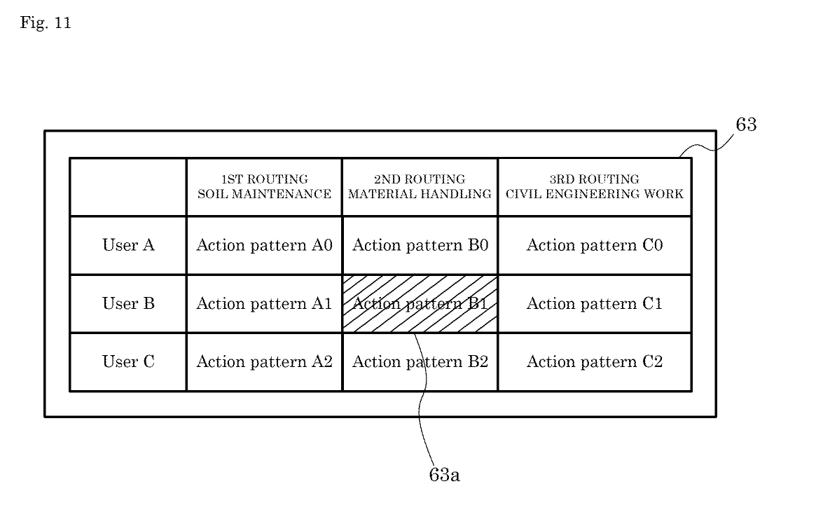

The alert receiver module 161 of the management terminal 60 receives the alert transmitted in Step S27. The alert display module 163 of the management terminal 60 displays the received alert in the input/output unit 63 as shown in FIG. 11.

FIG. 11 shows the alert displayed in the input/output unit 63 of the management terminal 60. In FIG. 11, a relevant part 63a of the user who took an action not matched with the previously set action record is shown as hatching. Thus, the management terminal 60 marks the action pattern of the user who took an action not matched with the previously set action record and displays as an alert. The management terminal 60, as shown in FIG. 10, may display the notification to warn a different action pattern of each user as an alert.

To achieve the means and the functions that are described above, a computer (including CPU, an information processor, and various terminals) reads and executes a predetermined program. For example, a program is provided in a form recorded in a computer-readable recording medium such as a flexible disk, a CD (e.g., CD-ROM), and a DVD (e.g., DVD-ROM and DVD-RAM). In this case, a computer reads a program from the recording medium, forwards and stores the program to and in an internal or an external storage, and executes it. For example, the program may be previously recorded in a memory (a record medium) such as a magnetic disk, an optical disk, and a magnetic optical disk, and then provided from the memory to the computer through a communication line.

The embodiments of the present invention are described above. However, the present invention is not limited to these embodiments. In addition, the effects described in these embodiments merely illustrate the most preferable effects resulting from the present invention, and the effects according to the present invention are not limited to those described in these embodiments.

### REFERENCE SIGNS LIST

1 Action analysis system
10 Action analysis server
60 Management terminal
100 Wearable terminal

What is claimed is:

1. An action analysis server communicatively connected with a wearable terminal worn by a user, comprising:
a receiver unit that regularly receives location data showing a user's current location or an acceleration data sensed by the wearable terminal as action data from the wearable terminal;
an action learning unit that learns a user's action at the received time frame based on the received action data and generating a learning record; and
an alert unit that executes an alert process when receiving action data not matched with the learning record from the wearable terminal.

2. The action analysis server according to claim 1, further comprising:
an action record generation unit that generates an action record based on the previously set action; and
a judgment unit that compares the action record with the received action data and judges whether or not the received action data is matched with the action record,
wherein the alert unit executes an alert process based on the judgment result from the judgment unit.

3. The action analysis server according to claim 2, wherein the alert unit executes a process to transmit a warning.

4. The action analysis server according to claim 3, wherein the alert unit notifies a time frame when an action data not matched with the learning record is received.

5. The action analysis server according to claim 1, wherein the alert unit executes a process to transmit a warning.

6. The action analysis server according to claim 5, wherein the alert unit notifies a time frame when an action data not matched with the learning record is received.

7. The action analysis server according to claim 1, wherein the alert unit notifies a time frame when an action data not matched with the learning record is received.

8. An action analysis method executed by an action analysis server communicatively connected with a wearable terminal worn by a user, comprising the steps of:
regularly receiving location data showing the user's current location or acceleration data sensed by the wearable terminal as action data from the wearable terminal;
learning the user's action at the received time frame based on the received action data and generating a learning record; and
executing an alert process when receiving action data not matched with the learning record from the wearable terminal.

9. A program product, for use in an action analysis server communicatively connected with a wearable terminal worn by a user, comprising a non-transitory computer usable medium having a set of instructions physically embodied therein, the set of instructions including computer readable code, which when executed by the action analysis server causes the information processing unit to:
regularly receive location data showing the user's current location or acceleration data sensed by the wearable terminal as action data from the wearable terminal;
learn the user's action at the received time frame based on the received action data and generate a learning record; and
execute an alert process when receiving action data not matched with the learning record from the wearable terminal.
